(19) United States
(12) Patent Application Publication
(10) Pub. No.: US 2006/0010877 A1
(43) Pub. Date: Jan. 19, 2006

(54) Method for the prevention of deposits in steam systems

(75) Inventors: Erhard Liebig, Laufenburg (DE); Robert Svoboda, Wettingen (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ALSTOM Technology Ltd.

(21) Appl. No.: 11/169,156

(22) Filed: Jun. 29, 2005

Related U.S. Application Data
(63) Continuation of application No. 10/106,105, filed on Mar. 27, 2002, now abandoned.

(30) Foreign Application Priority Data
Mar. 30, 2001 (DE) 10116034.8

(51) Int. Cl. F02C 3/30

(52) U.S. Cl. 60/775; 60/39.53

(57) ABSTRACT

In a method for preventing the deposition of impurities in steam systems, in which steam of a given steam quality flowing in them is subject to temperature and/or pressure changes, a simple prevention of deposits is achieved in that an appropriate structural configuration and design of the steam systems prevents the steam solubility of the impurities present in specific concentrations in the steam from being exceeded as a result of changes in the temperature and/or pressure conditions.

### FIELD OF THE INVENTION

The present invention relates to a method for preventing the deposition of impurities in steam systems, in which the steam of a given steam quality flowing in them is subjected to temperature and/or pressure changes. The invention also relates to a steam system for carrying out the method.

### BACKGROUND OF THE INVENTION

For the cooling of components subjected to high thermal load in energy machines, for example a gas turbine plant, it is intended, for reasons of efficiency, to make increasing use of steam as a coolant. This steam can flow as steam, but also as a steam/air mixture, in an open, semi-open or closed system through the components to be cooled.

In an open steam system, the steam is led from a device for the provision of steam (waste-heat boiler, steam turbine plant, auxiliary steam generator, etc.) to the device for the use of steam, for example a gas turbine plant, in order to cool the components of the latter while being heated. The cooling steam, after flowing through the cooling system of, for example, the gas turbine plant, passes into the working medium of the gas turbine plant and ultimately, together with this, into the atmosphere.

In a semi-open steam system, the steam is led from a device for the provision of steam (waste-heat boiler, steam turbine plant, auxiliary steam generator, etc.) to the device for the use of steam, for example a gas turbine plant, in order to cool the components of the latter while being heated. The cooling steam, after flowing through the cooling system of the gas turbine plant, is supplied to a device for steam take-off (waste-heat boiler, steam turbine plant, technological process, etc.).

In a closed steam system, the device for the provision of steam (steam cooler, steam blower, steam filter, etc.) is identical to the device for steam take-off. The device for the provision of steam makes steam having the appropriate parameters available to the device for the use of steam, in our case the gas turbine plant. After flowing through the cooling system of the gas turbine plant, the steam is returned to the device for the provision of steam, in order to carry out the pressure rise, cooling, cleaning and the like necessary for maintaining the circulation.

In the case of steam injection for an increase in power output, steam is injected as an additional working medium into the gas turbine plant in order to increase the mass flow of the working medium. This may, in turn, take place in the form of the direct injection of steam into the working medium or indirectly after the flow through of gas turbine components to be cooled. The steam may, however, also be injected in the form of a steam/air mixture, that is to say in combination with cooling air, into the working medium via an open air-cooling system, again indirectly, that is to say after the flow through of gas turbine components to be cooled.

The method of steam injection, that is to say steam introduction, into the working medium of the gas turbine plant is also employed in the Cheng cycle. In the Cheng cycle, to avoid the need for a steam turbine plant and the systems necessary for operating the steam turbine plant, the steam generated in the waste-heat boiler is injected completely into the gas turbine plant.

Impurities in the steam are distinguished by a particular steam solubility. In this context, where possible deposits are concerned, silicon dioxide (SiO₂) is particularly important because of the problems involved in the purification of make-up water and condensate and also on account of the difficulties in detection by measurement. SiO₂ will therefore be used below, by way of example, to represent the multiplicity of possible impurities.

The high-precision components of a gas turbine plant, the small dimensions of the cooling ducts, the stringent requirements to be met by the flow conditions and the like result in the need to ensure a high steam quality. Without this purity, deposits occur within the steam systems, the performance of the plants is diminished and inspections with corresponding shutdown periods of the plants become necessary. This is important, in particular, for the open and semi-open steam systems, because, in these systems, the cooling steam constantly has to be provided anew, and therefore new impurities may always enter the system.

This results, not least for the steam generator technology employed, in numerous constraints, for example with regard to component design (steam drying in drums and separators), steam temperature regulation by water injection or steam mixing, the chemical operating modes, etc.

Attempts are being made, at the present time, by appropriate steam provision and steam purification concepts, to ensure a steam quality which avoids deposits with a high degree of reliability. Thus, numerous steam mixing methods are known so the steam temperature can be regulated without water injection. Furthermore, special steam filters, in particular for closed steam systems, are recommended.

For steam applications of this kind with an adversely high technical and therefore also financial outlay, all these attempts are based on ensuring the generation of very pure water, further improving the quality of this water by means of condensate purification plants, avoiding contamination of the steam by means of appropriate methods of steam generation and steam parameter regulation, freeing the steam of impurities by means of suitable filters and preventing chemical interactions, for example corrosion, in the respective systems by a suitable choice of material.

### SUMMARY OF THE INVENTION

The object on which the invention is based, therefore, is to make available a method for preventing the deposition of impurities in steam systems, in which method the disadvantages of the prior art are avoided.

The solution according to the invention for achieving the above object, in steam systems of this kind, in which the steam of a given steam quality flowing in them is subjected to temperature and/or pressure changes, is, by an appropriate structural configuration and design of the steam systems, to prevent the steam solubility of the impurities present in specific concentrations in the steam from being exceeded as a result of changes in the temperature and/or pressure conditions.

The essence of the invention, therefore, is not, as hitherto according to the prior art, to bring the quality, that is to say the purity, of the steam to a specific very low value preventing deposits with high probability, but, instead, under the conditions given in practice for the steam quality and according to the solubility behavior of the impurities, to prevent a situation where a separation of the impurities in a steam system can occur at all. To be precise, it becomes clear, surprisingly, that the total “prepurification” of the water or of the steam is not actually necessary at all, but that it is sufficient to avoid critical parameters being reached in the steam system, that is to say to avoid steam parameters which entail a separation of impurities.

This is carried out in that, by a suitable choice of the design parameters and/or by an appropriate routing of the steam in the system, or, if appropriate, by appropriately ensuring the temperature, the temperature and pressure parameters never assume values which make a separation of impurities possible. In other words, it is crucial to prevent an excessive lowering of temperature and/or pressure to a critically low value. This may take place in many different ways, either by preventing a critical lowering of the temperature by an increase in the steam mass flow and/or by a reduction in cooling external influences and/or else also by the steam experiencing a corresponding temperature increase, particularly in critical regions of the steam system. Influence can be exerted on the pressure in that, by the type and configuration of steam routing in the steam system, the flow conditions are designed in such a way that pressure losses, particularly in critical regions, are avoided.

A first embodiment of the method according to the invention is distinguished in that the impurities are silicon dioxide (SiO₂).

In a further embodiment of the method, the method is employed in the case of steam cooling or steam injection of a gas turbine plant. These are two particularly important applications of steam in gas turbine plants.

Moreover, as an additional measure for the prevention of deposits, there may be provision for the temperature and/or pressure of the steam flowing in the steam system to be set in such a way that the steam solubility of the impurities present in a specific concentration in the steam is not exceeded in the steam system. The latitude for the temperature and/or pressure parameters of the steam flowing in steam systems is usually sufficient to reduce even further the risk of deposits by a specific selection or optimization of at least one of these parameters.

The method can be organized in a particularly advantageous way in that both values are monitored simultaneously and the pair of values, namely the pressure and temperature of the steam in the steam system, never assumes a critical value, and in that particularly critical regions of the steam system with significant pressure drops are avoided. In particular, this may also be carried out in that a lowering of the pressure such that the steam solubility of the impurities present in specific concentrations in the steam would be exceeded is compensated by means of a corresponding rise in the temperature.

As regards steam/air mixtures, it must be remembered that, in this case, the partial pressure of the steam in the mixture must be adopted as pressure quantity for the steam pressure.

A further exemplary embodiment of the invention is characterized in that the sole critical pressure drop in the steam system is placed at the outlet point of the steam from the device for the use of steam. Thus, deposits will occur at most in the outlet region which is easy to clean. If, moreover, the flow velocities of the steam are high at the outlet point, a self-cleaning effect may be established.

The invention comprises, furthermore, a steam system for carrying out one of the above-described methods.

### BRIEF DESCRIPTION OF THE DRAWINGS

The invention will be explained in more detail below by means of exemplary embodiments in conjunction with the drawings in which:

FIG. 1 shows a solubility diagram for SiO₂ in water and steam,

FIG. 2 shows an i,s-graph with lines of constant steam solubility of SiO₂, and

FIG. 3 shows an i,s-graph according to FIG. 2 with the parameter profile in a semi-open steam system.

### DETAILED DESCRIPTION OF THE INVENTION

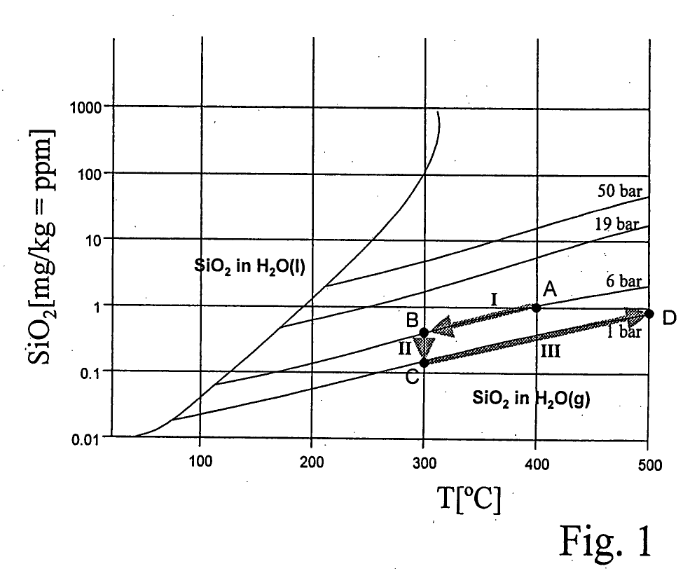

The steam solubility of impurities depends essentially on the pressure and temperature parameters. In general, with a rise in temperature and a rise in pressure, their steam solubility rises and vice versa, the pressure influence being dominant. FIG. 1 shows by way of example for all impurities a diagram for the solubility of SiO₂ in water or steam as a function of the temperature at pressures of 1 bar, 6 bar, 19 bar and 50 bar. It is clear that, for a pressure of 6 bar and a temperature of 400° C., SiO₂ is soluble in steam up to a concentration of approximately 1 mg/kg (1000 ppb).

In spite of this behavior which is known per se, for the prevention of deposits in steam systems, it has hitherto always been concluded that only by ensuring the conditions corresponding to the most unfavorable case and therefore by the lowest concentration of SiO₂ or of another impurity is it possible for a deposition of this to be effectively prevented. Thus, to avoid SiO₂ deposits in steam systems, concentrations of less than 0.02 mg/kg (SiO₂<20 ppb) are predetermined as standard values.

Since the provision of steam of such purity, particularly in open and semi-open steam systems, is costly, the attempt according to the invention is based on avoiding critical pressure and temperature values in the system at which deposits of impurities could occur.

Temperatures in the range of 250 to 580° C. and pressures in the range of 20 to 40 bar typically prevail in steam systems of gas turbine plants (steam cooling, steam injection, etc.).

By a gas turbine plant is meant below a plant consisting of at least one compressor, of at least one combustion chamber and of at least one gas turbine. Air is sucked in and compressed by the compressor and is then supplied as combustion air to a combustion chamber, and the hot gas occurring there is expanded in a gas turbine so as to perform work. The at least one gas turbine and the at least one compressor are located on one shaft.

By virtue of the multiplicity of possibilities resulting from the combination of the steam systems, the function of the steam system, the components through which steam flows and the like in a gas turbine plant, the device for the use of steam may, in a gas turbine plant, be the entire plant, but also, for example, only one component of the casing or a blade row.

However, the problem of the prevention of deposits is not only relevant to steam systems in which the steam is heated up, as explained by the example of the steam-cooling system of gas turbine plants, but also the use of steam for heating purposes in which the steam experiences a lowering of temperature. By the term “steam system” are therefore meant, in general, steam-cooling systems, but also steam-heating systems.

FIG. 1, then, illustrates, furthermore, various parameter changes together with the resulting effects on the steam solubility, again by the example of silicon dioxide (SiO₂).

First, the arrow I illustrates an isobaric transition from a state A with p=6 bar and T=400° C. into a state B with p=6 bar and T=300° C. It can easily be seen that a pressure reduction of this kind may already lead to the separation of SiO₂. If the maximum SiO₂ concentration soluble in steam amounted at the point A to 1.0 mg/kg (1000 ppb), it fell back to a value of 0.14 mg/kg (140 ppb) at the point B.

The arrow II illustrates an isothermal transition from the state B into the state C with p=1 bar and T=300° C. It can be seen, again, that a lowering of temperature of this kind may likewise lead to the separation of SiO₂. When the maximum SiO₂ concentration soluble in steam amounts to 0.14 mg/kg (140 ppb) at the point B, it falls back to a value of 0.11 mg/k (110 ppb) at the point C.

The arrow III illustrates an isobaric transition from the state C into the state D with p=1 bar and T=500° C. It can be seen, again, that, in contrast to the previous changes of state, a temperature rise of this kind in this case leads to an increase in the steam solubility of SiO₂. When the maximum SiO₂ concentration soluble in steam amounts to 0.11 mg/kg (110 ppb) at the point C, it rises to a value of 0.18 mg/kg (180 ppb) at the point D. A temperature rise is therefore appropriate for counteracting or compensating a reduction in the steam solubility of the impurities due to a pressure drop.

By utilizing the solubility behavior of impurities, then, deposits in steam systems can be avoided in that
the design parameters selected for pressure and/or temperature are sufficiently high,
care is taken to ensure that the steam solubility of impurities is never reached or exceeded due to a pressure and/or temperature drop, or
in that the fall in steam solubility as a result of a pressure drop is partially or completely compensated by a temperature rise.

According to the invention, then, parameter configurations in steam systems which are critical in terms of possible separations of impurities are avoided in that care is taken, at a process level and flow level, to ensure that the limit for possible separations is never reached or exceeded. This is achieved in that, by means of the system design,
when there is a need to control pronounced pressure and/or temperature drops, the design parameters selected for pressure and/or temperature are sufficiently high,
a critical combination of pressure drop and temperature drop is avoided,
a critical lowering of the steam solubility as a result of pronounced pressure drops is compensated by a corresponding heating of the steam and consequently a temperature rise.

Gas turbine plants are employed frequently, virtually without exception in current generation, together with waste-heat boilers. Waste-heat boilers have up to three pressure stages and, possibly, intermediate super heating. There is therefore a multiplicity of possibilities for influencing the parameters of a corresponding steam system.

Pronounced pressure and/or temperature drops in steam systems can be avoided by means of an appropriate design of the flow cross sections, selection of steam mass flows and the like.

If, as illustrated by the example of the gas turbine plant, the steam serves for the cooling of components, the steam undergoes heating by heat absorption. Care must be taken, then, to ensure, in structural terms, that appropriate heating of the cooling steam takes place upstream of and/or in regions with a significant pressure drop.

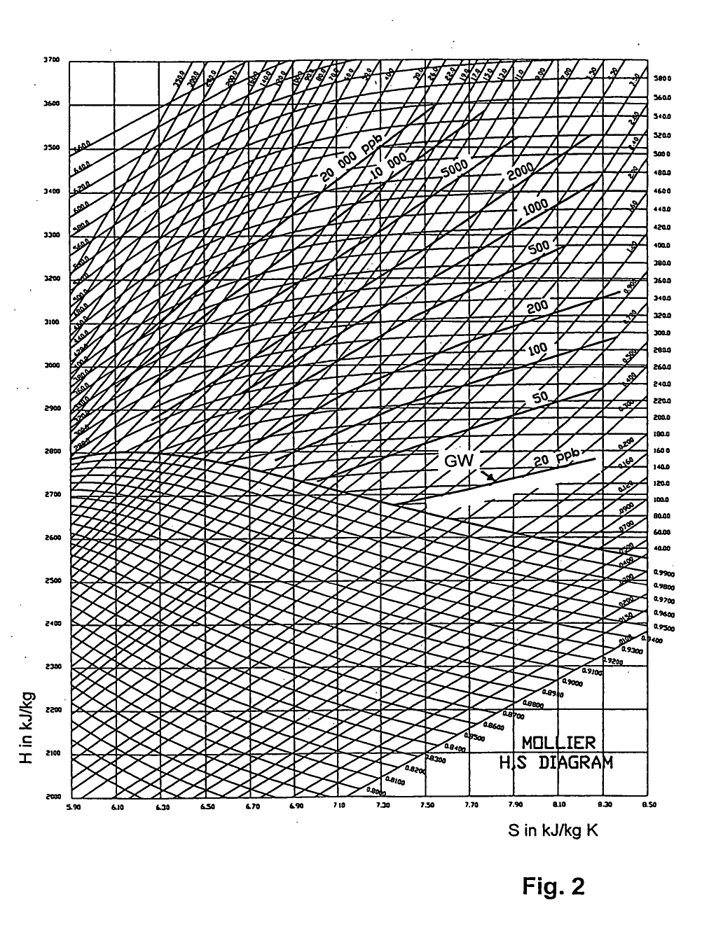

FIG. 2 shows an h,s-diagram with lines of constant SiO₂ solubility in steam. The steam solubility decreasing with a fall in pressure and a fall in temperature can be seen again. The lines of constant SiO₂ steam solubility interestingly correspond approximately to the angle bisecting line between the lines of constant pressure and the lines of constant temperature. The limit value (GW) for steam turbines is also illustrated.

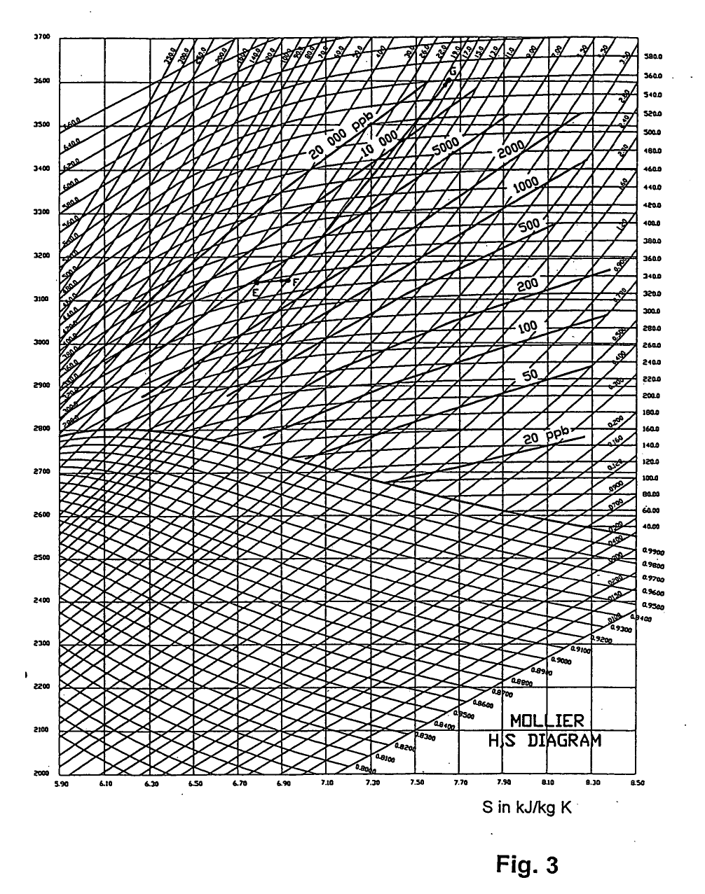

FIG. 3 illustrates, additionally to FIG. 2, the changes of state to the steam within the steam system, in the present case a semi-open steam-cooling system of a gas turbine plant, in the form of an h,s-diagram (x-axis: entropy, y-axis: enthalpy). The cooling steam has a pressure of 30 bar and a temperature of 360° C. at the point E (outlet from the device for the provision of steam). As far as the gas turbine plant or the component to be cooled (device for the use of steam), for example a blade, pressure losses of approximately 8 bar and temperature losses of approximately 5 K occur. The steam therefore has a pressure of approximately 22 bar and a temperature of 355° C. at the point F (inlet into the device for the use of steam). This pressure loss is accompanied by a sharp decrease in steam solubility. During the flow through of the components to be cooled (device for the use of steam), further pressure losses of the order of magnitude of 4 bar occur. However, the steam is heated by approximately 200 K. At the outlet of the component to be cooled, therefore, the steam has a pressure of 18 bar and a temperature of 560° C. at the point G (outlet from the device for the use of steam). With these parameters, then, the steam is supplied to a device for steam take-off. As a result of the temperature rise, there is a marked increase in the steam solubility of SiO₂ within the device for the use of steam. For the process illustrated, to prevent SiO₂ deposits, it will be sufficient to maintain a limit value for the SiO₂ concentration of 3000 ppb (3 mg/kg). It can be seen, furthermore, that the region critical for deposits is the inlet region of the steam into the component to be cooled (device for the use of steam). However, the limit value GW conventionally used for steam systems and specified for steam turbine plants amounts to only 20 ppb.

Somewhat different conditions arise with regard to steam/air mixtures. In this case, the partial pressure of the steam, dependent on the steam concentration, must be adopted for the steam pressure. There are therefore low partial pressures of the steam, particularly at low steam concentrations, which, in turn may lead to very low steam solubilities of the respective impurity. This can be remedied by maintaining a minimum steam concentration.

Under the conditions mentioned, it is advantageous to provide a significant pressure drop in the steam system at the point of outlet of the steam from the component to be cooled or from the device for the use of steam and, at the same time, implement as high an outlet velocity of the steam as possible. Consequently, the deposition of impurities, for example as a result of unusual operating conditions, would be concentrated firstly at easily accessible points and therefore points which are easy to clean. Owing to the self-cleaning effect established with an increase in steam velocity, the deposition of impurities can be limited and, in the best possible case, prevented.

1. A method for preventing the deposition of silicon dioxide (SiO₂) impurities in a steam system, in which the steam of a given steam quality flowing in the steam system is subjected to temperature and/or pressure changes, the method comprising providing a structural configuration and design of the steam system that prevents the steam solubility of the silicon dioxide (SiO₂) impurities present in specific concentrations in the steam from being exceeded as a result of changes in the temperature and/or pressure conditions within the steam system.

2. (canceled)

3. The method as claimed in claim 1, wherein the steam system is steam cooling or steam injection of a gas turbine plant.

4. The method as claimed in claim 1, wherein, additionally, the temperature and/or pressure of the steam flowing in the steam system is set to prevent the steam solubility of the silicon dioxide impurities present in specific concentrations in the steam from being exceeded in the steam system.

5. The method as claimed in claim 1, wherein the structural configuration and design of the steam act system acts in such a way that a pair of pressure and temperature values of the steam in the steam system never assumes a value at which the steam solubility of the silicon dioxide impurities present in specific concentrations in the steam is exceeded, and in critical regions with significant pressure drops, without a simultaneous equivalent rise in temperature of the steam, are avoided.

6. The method as claimed in claim 5, comprising compensating a drop in the pressure that would cause the steam solubility of the silicon dioxide impurities present in specific concentrations in the steam to be exceeded by a corresponding rise in the temperature.

7. The method as claimed in claim 1, wherein for steam/air mixtures, the partial pressure of the steam in the steam/air mixture is the pressure quantity.

8. The method as claimed in claim 1, comprising placing a sole critical pressure drop in the steam system at the outlet point of the steam from the device for the use of steam.

9. The method as claimed in claim 8, wherein the flow velocity of the steam at the outlet point of the steam from the device for the use of steam is sufficiently high that a self-cleaning effect is established at the outlet point.

10. (canceled)
